(19) United States
(12) Patent Application Publication
(10) Pub. No.: US 2026/0178650 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventor: Satoshi MIYAKE, Toyota-shi (JP)

(73) Assignee: TOYOTA JIDOSHA KABUSHIKI KAISHA, Toyota-shi (JP)

(21) Appl. No.: 19/404,162

(22) Filed: Dec. 1, 2025

(30) Foreign Application Priority Data
Dec. 25, 2024 (JP) 2024-229169

(51) Int. Cl. G06F 16/355; G06F 40/279

(52) U.S. Cl. CPC G06F 16/355; G06F 40/279

(57) ABSTRACT

An information processing device includes an acquisition unit that acquires document data, a first extraction unit that extracts a first keyword from the document data in its entirety, a second extraction unit that extracts a second keyword from a text box included in the document data, a determining unit that finds a difference set between the first keyword and the second keyword, and determines a non-redundant keyword based on the difference set, and a classification unit that classifies the document data by assigning a classification tag to the document data. The classification unit excludes the classification tag related to the non-redundant keyword from candidates for the classification tag to be assigned to the document data, and then assigns the classification tag.

### CROSS-REFERENCE TO RELATED APPLICATION

This application claims priority to Japanese Patent Application No. 2024-229169 filed on December 25, 2024. The disclosure of the above-identified application, including the specification, drawings, and claims, is incorporated by reference herein in its entirety.

### BACKGROUND

### 1. Technical Field

This disclosure relates to the technical field of information processing devices.

### 2. Description of Related Art

As an example of this type of system, a system has been proposed in which a large language model (LLM) is used to generate query data based on documents, and pairs of the documents and the query data are used to train a retrieval model for a dialogue bot (see Japanese Unexamined Patent Application Publication No. 2023-076413 (JP 2023-076413 A)).

### SUMMARY

When document data is classified using a model trained by machine learning such as an LLM or the like, there is a risk of performing erroneous classification. However, it is difficult to automatically detect erroneous classification that has been performed.

This disclosure has been made in consideration of the above-mentioned problem, and an object thereof is to provide an information processing device that can appropriately classify document data.

An information processing device according to an aspect of the present disclosure includes an acquisition unit that acquires document data, a first extraction unit that extracts a first keyword from the document data in its entirety, a second extraction unit that extracts a second keyword from a text box included in the document data, a determining unit that finds a difference set between the first keyword and the second keyword, and determines a non-redundant keyword based on the difference set, and, a classification unit that classifies the document data by assigning a classification tag to the document data, in which the classification unit excludes the classification tag related to the non-redundant keyword from candidates for the classification tag to be assigned to the document data, and then assigns the classification tag.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of an information processing device according to an embodiment;

FIG. 2 is a block diagram illustrating a functional configuration of the information processing device according to the embodiment;

FIG. 3 is a flowchart showing a flow of operations of the information processing device according to the embodiment; and

FIG. 4 is a schematic diagram illustrating an example of operations for extracting a keyword.

### DETAILED DESCRIPTION OF EMBODIMENTS

An embodiment of an information processing device will be described below with reference to the drawings.

### Hardware Configuration

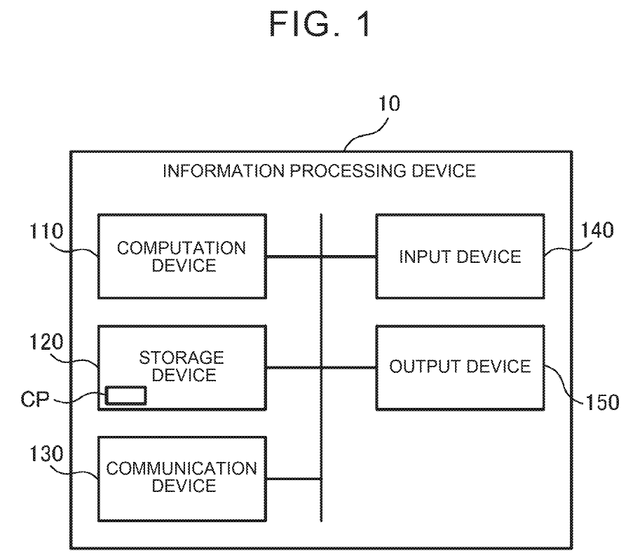

First, a hardware configuration of the information processing device according to the embodiment will be described with reference to FIG. 1. FIG. 1 is a block diagram illustrating the hardware configuration of the information processing device according to the embodiment.

In FIG. 1, the information processing device 10 according to the embodiment is made up of a computation device 110, a storage device 120, a communication device 130, an input device 140, and an output device 150. The computation device 110, the storage device 120, the communication device 130, the input device 140, and the output device 150 are connected to one another via a data bus.

The computation device 110 is configured to be capable of executing various types of computation processing in the information processing device 10. The computation device 110 may include a processor. The computation device 110 may have a single processor, or may have a plurality of processors. That is to say, the computation device 110 may have one or more processors. Note that the processor may be a multi-core processor. When the computation device 110 has a single processor that is a multi-core processor, the computation device 110 may be regarded as logically having a plurality of processors.

The processor that the computation device 110 has may be, for example, at least one of a central processing unit (CPU), a graphics processing unit (GPU), a field programmable gate array (FPGA), and a tensor processing unit (TPU).

The storage device 120 may be, for example, at least one of random access memory (RAM), read-only memory (ROM), a hard disk drive, a magneto-optical disk drive, a solid-state drive (SSD), and an optical disc array. That is to say, the storage device 120 may be realized using a single device or may be realized using a plurality of devices.

The storage device 120 is capable of storing data that is desired. The storage device 120 may store a computer program CP that is executed by the computation device 110. When the computation device 110 is executing the computer program CP, the storage device 120 may temporarily store data temporarily used by the computation device 110.

Note that the computer program CP may be recorded on a computer-readable and non-transitory recording medium. In this case, the computer program CP may be stored in the storage device 120 by reading the recording medium using a recording medium reading device, omitted from illustration, which is included in the information processing device 10. Note that at least one of an optical disc, a magnetic medium, a magneto-optical disc, semiconductor memory, and any other medium capable of storing programs, may be used as the above recording medium. The computer program CP may be acquired from a device, omitted from illustration, which is external to the information processing device 10, via the communication device 130. In other words, the computer program CP may be downloaded from an external device to the storage device 120 of the information processing device 10.

The computation device 110 (e.g., processor), together with the storage device 120 storing the computer program CP (i.e., together with storage device 120 and computer program CP stored in storage device 120), may execute processing to be performed by the information processing device 10. For example, logical functional blocks for executing processing to be performed by the information processing device 10 may be realized within the computation device 110 (e.g., within the processor) by the computation device 110 executing the computer program CP.

The communication device 130 is configured to be capable of communicating with devices that are external to the information processing device 10. Note that the communication device 130 may perform wired communication or may perform wireless communication.

The input device 140 is a device capable of externally receiving input of information to the information processing device 10. The input device 140 may include an operation device operable by a user of the information processing device 10 (e.g., keyboard, mouse, touch panel, and so forth). The input device 140 may include, for example, a recording medium reading device that is capable of reading information recorded in a recording medium such as Universal Serial Bus (USB) memory, or the like, that is attachable to and detachable from the information processing device 10. Note that when information is input to the information processing device 10 via the communication device 130 (i.e., when information processing device 10 acquires information via communication device 130), the communication device 130 may function as an input device.

The output device 150 is a device capable of externally outputting information from the information processing device 10. The output device 150 may have a display device that is capable of outputting visual information, such as text, images, or the like, as the above information. The output device 150 may have a speaker that is capable of outputting auditory information such as sound or the like as the above information. The output device 150 may be configured to output the above information (e.g., control information or the like for other devices) to other devices. The output device 150 may be capable of outputting information to a recording medium that is attachable to and detachable from the information processing device 10, such as for example, USB memory or the like. Note that when the information processing device 10 outputs information via the communication device 130, the communication device 130 may function as an output device.

### Functional Configuration

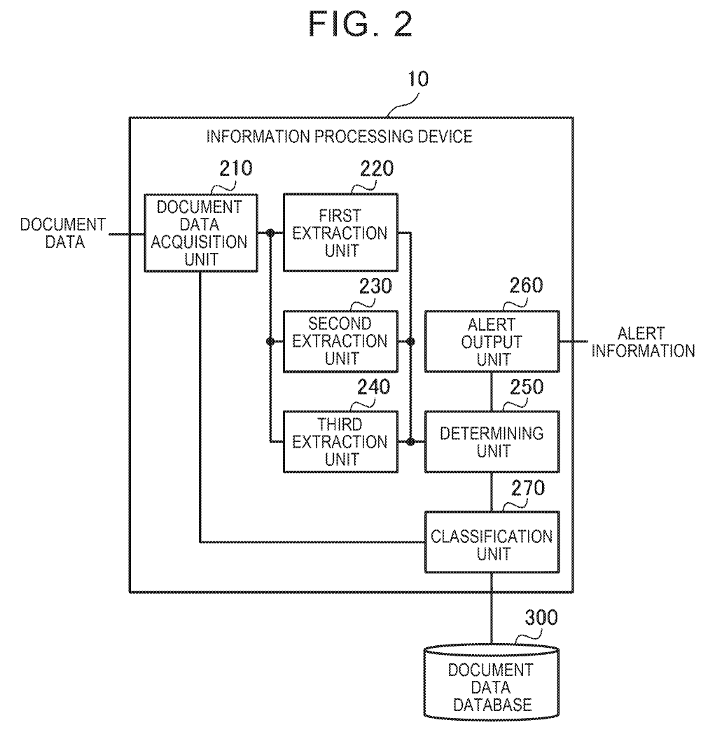

Next, a functional configuration of the information processing device 10 according to the embodiment will be described with reference to FIG. 2. FIG. 2 is a block diagram illustrating the functional configuration of the information processing device according to the embodiment.

In FIG. 2, the information processing device 10 is configured as a device that classifies document data and stores the document data in a document data database 300. The information processing device 10 includes, as components for realizing functions thereof, a document data acquisition unit 210, a first extraction unit 220, a second extraction unit 230, a third extraction unit 240, a determining unit 250, an alert output unit 260, and a classification unit 270. Note that each of the document data acquisition unit 210, the first extraction unit 220, the second extraction unit 230, the third extraction unit 240, the determining unit 250, the alert output unit 260, and the classification unit 270, may be a processing block realized by the computation device 110 that is described above.

The document data acquisition unit 210 is configured to be capable of acquiring document data. Document data is data that includes text, and examples thereof include technical documents, specifications, and so forth. The document data may be data that includes images in addition to text. The document data acquisition unit 210 may acquire document data input by a user, for example. Alternatively, the document data acquisition unit 210 may acquire, from storage or the like, document data that is stored therein in advance.

The first extraction unit 220 is configured to be capable of extracting a first keyword from the document data in its entirety. The first keyword may be a keyword that is highly important when viewing the document data in its entirety. The first keyword may be, for example, a keyword that appears frequently throughout the document data in its entirety. The first extraction unit 220 may extract a plurality of the first keywords from one piece of document data.

The second extraction unit 230 is configured to be capable of extracting a second keyword from text boxes included in the document data. The second keyword may be a keyword of high importance in a text block. The second keyword may be, for example, a keyword used in a heading of a text block. It should be noted that the term "text block" here refers to a group of sentences (a lump of sentences) in document data, and is not limited to that which is divided into block forms. For example, a text block may be a paragraph. The second extraction unit 230 may extract a plurality of the second keywords from one text block.

The third extraction unit 240 is configured to be capable of extracting a third keyword from images included in the document data. The third keyword may be extracted from text contained in the image. Alternatively, the third keyword may be extracted from a summary of the image. Alternatively, the third keyword may be extracted by recognizing an object in the image. The third extraction unit 240 may extract a plurality of the third keywords from one image.

The determining unit 250 determines non-redundant keywords among the first keywords extracted by the first extraction unit 220, the second keywords extracted by the second extraction unit 230, and the third keywords extracted by the third extraction unit 240. More specifically, the determining unit 250 finds a difference set with respect to the first keywords, the second keywords, and the third keywords, and determines non-redundant keywords based on the difference set.

The alert output unit 260 calculates the proportion of non-overlapping keywords determined by the determining unit 250 among all keywords extracted by the first extraction unit 220, the second extraction unit 230, and the third extraction unit 240 (hereinafter referred to as the "non-redundant proportion" as appropriate). The alert output unit 260 is configured to output alert information when the non-redundant proportion exceeds a predetermined threshold value. The alert information may be information that is output to the user. The alert information may be displayed as text or an image on a display or the like, for example. Alternatively, the alert information may be output as sound from a speaker or the like. The alert information may be information that makes notification that classification errors are likely to occur in the document data being processed. The alert information may be, for example, information that prompts a manual classification check to be performed.

The classification unit 270 is configured to be capable of classifying document data by assigning classification tags to the document data. For example, the classification unit 270 selects and assigns classification tags suitable for the document data from among a plurality of classification tags prepared in advance. Note that the classification unit 270 may perform classification using a method other than the method of assigning classification tags. The classification unit 270 may classify the document data using a model that has been trained by machine learning. This model may be a model that takes document data as input and outputs classification tags to be assigned to the document data. The classification unit 270 may be configured to store the classified document data in a document data database.

In particular, the classification unit 270 excludes classification tags related to non-redundant keywords determined by the determining unit 250 from being candidates for classification tags to be assigned to document data, and then assigns classification tags. Accordingly, the classification tags related to non-redundant keywords are not assigned to the document data.

The document data database 300 is configured to be capable of storing the document data classified by the classification unit 270. The document data stored in the document data database 300 may be readable as appropriate. For example, the document data stored in the document data database 300 may be configured to be searchable using classification tags as conditions.

Note that while FIG. 2 illustrates an example in which the document data database 300 is provided externally from the information processing device 10, the information processing device 10 may be configured to include the document data database 300.

### Flow of Operations

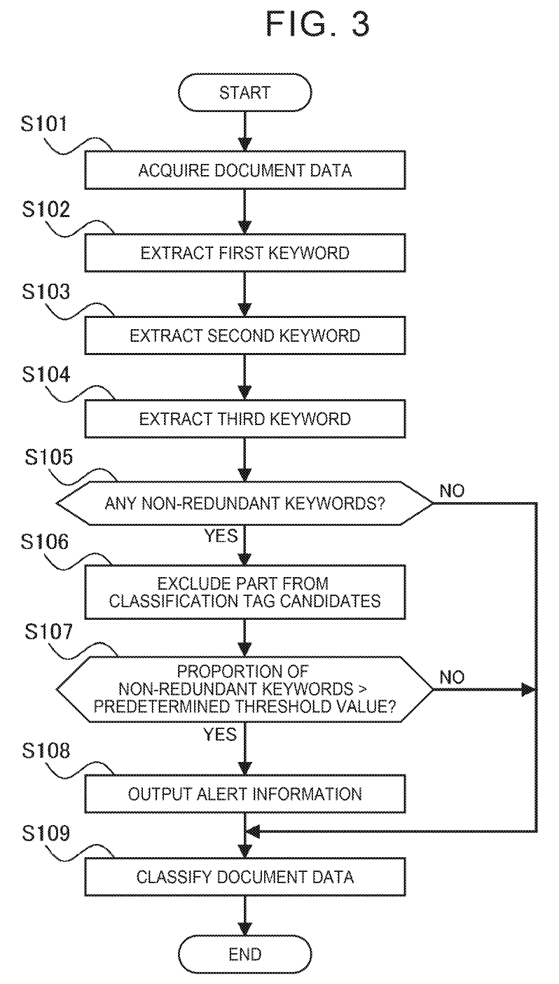

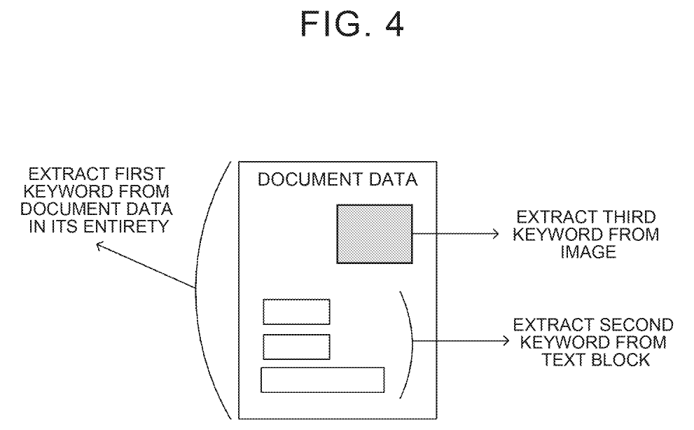

Next, a flow of operations of the information processing device 10 according to the embodiment will be described with reference to FIGS. 3 and 4. FIG. 3 is a flowchart showing the flow of operations of the information processing device according to the embodiment. FIG. 4 is a schematic diagram illustrating an example of operations for extracting a keyword.

As shown in FIG. 3, when operations of the information processing device 10 according to the embodiment are started, the document data acquisition unit 210 first acquires document data (step S101). The first extraction unit 220 then extracts first keywords (step S102). The second extraction unit extracts second keywords (step S103). The third extraction unit extracts third keywords (step S104).

As illustrated in FIG. 4, the first extraction unit 220 extracts first keywords from the document data in its entirety. The second extraction unit 230 extracts second keywords from text blocks included in the document data. The third extraction unit 240 extracts third keywords from images included in the document data. Note that the order in which the first keywords, the second keywords, and the third keywords are extracted is not limited in particular. That is to say, the processing of steps S102, S103, and S104 may be executed in succession, or may be executed simultaneously in parallel.

Returning to FIG. 3, once the keywords have been extracted, the determining unit 250 finds the difference set among the first keyword, the second keyword, and the third keyword, and determines whether there are any non-redundant keywords (step S105). Note that when there are no non-redundant keywords (no in step S105), the document data is classified (step S109) as it is, and the series of operations ends.

On the other hand, when there are non-redundant keywords (yes in step S105), the classification unit 270 excludes classification tags related to the non-redundant keywords from the candidates for classification tags to be assigned to the document data (step S106).

The alert output unit 260 also determines whether the proportion of non-redundant keywords exceeds the predetermined threshold value (step S107). When the proportion of non-redundant keywords exceeds the predetermined threshold value (yes in step S107), the alert output unit 260 outputs alert information (step S108). On the other hand, when the proportion of non-redundant keywords does not exceed the predetermined threshold value (no in step S107), step S108 is skipped. That is to say, the alert output unit 260 does not output alert information.

Thereafter, the classification unit 270 classifies the document data (step S109). Here, in step S106, classification tags related to non-redundant keywords are excluded from being candidates for classification tags to be assigned to document data. Accordingly, the classification unit 270 selects classification tags to be assigned to the document data from among the classification tags that are not excluded.

### Technical Effects

Next, technical effects obtained by the information processing device 10 according to the embodiment will be described.

As described with reference to FIGS. 1 to 4, the information processing device 10 according to the embodiment determines non-redundant keywords from keywords extracted from each of the document data in its entirety, text blocks, and images. Classification tags related to non-redundant keywords are then excluded from being candidates, and the document data is classified. Thus, a classification tag related to a keyword that is not closely related to the document data can be suppressed from being assigned. That is to say, erroneous classification can be suppressed from being performed. In particular, according to the present embodiment, keywords extracted from each of the document data in its entirety, text blocks, and images, are used, and accordingly the importance of keywords can be determined from various perspectives, and inappropriate classification tags can be excluded in advance.

Aspects of the disclosure derived from the above-described embodiment will be described below.

An information processing device according to an aspect of this disclosure includes an acquisition unit that acquires document data, a first extraction unit that extracts a first keyword from the document data in its entirety, a second extraction unit that extracts a second keyword from a text box included in the document data, a determining unit that finds a difference set between the first keyword and the second keyword, and determines a non-redundant keyword based on the difference set, and, a classification unit that classifies the document data by assigning a classification tag to the document data, in which the classification unit excludes the classification tag related to the non-redundant keyword from candidates for the classification tag to be assigned to the document data, and then assigns the classification tag. In the above-described embodiment, "document data acquisition unit 210" corresponds to an example of "acquisition unit", "first extraction unit 220" corresponds to an example of "first extraction unit", "second extraction unit 230" corresponds to an example of "second extraction unit", "determining unit 250" corresponds to an example of "determining unit", and "classification unit 270" corresponds to an example of "classification unit".

The information processing device according to the above aspect may further include a third extraction unit that extracts a third keyword from an image included in the document data, in which the determining unit finds a difference set among the first keyword, the second keyword, and the third keyword, and determines the non-redundant keyword based on the difference set. Thus, non-redundant keywords can be determined while taking into consideration images contained in the document data. In the above-described embodiment, "third extraction unit 240" corresponds to an example of "third extraction unit".

The information processing device according to the above aspect may further include an alert unit that outputs alert information when a proportion of the non-redundant keyword to all keywords that are extracted exceeds a predetermined threshold value. Thus, the user can be notified that the proportion of non-redundant keywords is high. In this case, manual checking and so forth, for example, may be performed. In the above-described embodiment, "alert output unit 260" corresponds to an example of "alert unit".

This disclosure is not limited to the embodiment described above, and various modifications can be made as appropriate without departing from the gist or spirit of the disclosure that can be read from the claims and the specification in its entirety, and information processing devices incorporating such modifications also fall within the technical scope of the present disclosure.

What is claimed is:

1. An information processing device comprising:
an acquisition unit that acquires document data;
a first extraction unit that extracts a first keyword from the document data in its entirety;
a second extraction unit that extracts a second keyword from a text box included in the document data;
a determining unit that finds a difference set between the first keyword and the second keyword, and determines a non-redundant keyword based on the difference set; and
a classification unit that classifies the document data by assigning a classification tag to the document data, wherein
the classification unit excludes the classification tag related to the non-redundant keyword from candidates for the classification tag to be assigned to the document data, and then assigns the classification tag.

2. The information processing device according to claim 1, further comprising a third extraction unit that extracts a third keyword from an image included in the document data, wherein the determining unit finds a difference set among the first keyword, the second keyword, and the third keyword, and determines the non-redundant keyword based on the difference set.

3. The information processing device according to claim 1, further comprising an alert unit that outputs alert information when a proportion of the non-redundant keyword to all keywords that are extracted exceeds a predetermined threshold value.
